(19) United States
(12) Patent Application Publication
(10) Pub. No.: US 2026/0280781 A1
(43) Pub. Date: Sep. 17, 2026

(54) RADIO SIGNAL DEVICE AND METHOD FOR SYNCHRONISATION AND DATA TRANSMISSION OF A RADIO SIGNAL

(71) Applicant: EUROPEAN SPACE AGENCY, Noordwijk (NL)

(72) Inventors: Jose Antonio GARCIA MOLINA, Noordwijk (NL); Rigas IOANNIDES, Noordwijk (NL); Juan Manuel PARRO JIMENEZ

(21) Appl. No.: 19/161,855

(22) PCT Filed: Mar. 8, 2023
(86) PCT No.: PCT/EP2023/055893

§ 371 Date: Sep. 3, 2025

(51) Int. Cl. H04L 5/00; G01S 19/24; G01S 19/30; H04L 27/26

(52) U.S. Cl. CPC H04L 5/0021; G01S 19/243; G01S 19/30; H04L 5/0048; H04L 27/26136; H04L 27/2666

(57) ABSTRACT

The invention relates to a radio signal device and method for synchronizing, transmitting and receiving data using multi-carrier signals, where the radio signal enables its simultaneous exploitation at reception level as pilot signal component and data signal component. A radio signal device adapted for transmitting a radio signal, wherein the transmitted radio signal z(k,t) comprises blocks, each block comprises a pilot symbol d. The radio signal device is adapted to determine and transmit the pilot symbol by generating a baseline multi-carrier pilot signal b(t), and modulate the baseline multi-carrier pilot signal b(t) with a data symbol sₖ, such that each baseline frequency component bi(t) is multiplied by the i-th element s_{k,i} of the data symbol sₖ. Further, the invention relates to a radio signal device adapted for receiving such a radio signal.

### FIELD OF THE INVENTION

The present invention relates to a radio signal device and method for transmitting and receiving a radio signal using multi-carrier signals, while enabling the usage of the same multi-carrier signals for synchronization purposes.

### BACKGROUND OF THE INVENTION

Multi-Carrier (MC) modulation is widely used in communications systems, and it is considered as a potential candidate for Global Navigation Satellite Systems (GNSS) [1-4]. The principle behind MC modulation is to parallelize a serial flow of data into a plurality of frequency subcarriers, which are normally closely spaced. The respectively assigned pieces of transmission data are modulated and thus multiplexed by the subcarriers.

Current or known GNSS signals typically are divided in two general types: pilot signals components and data signal components. The former signals are of interest for flexible acquisition and tracking purposes, i.e., for synchronization purposes, enabling the adaptive application of both short and long coherent integration and processing periods, depending on the receiver application and/or the channel propagation conditions. The latter signals are of interest for the dissemination of data useful for the GNSS receiver.

Typically, both types of signals are used in a complementary way for getting the benefit of each of them. The main drawback of transmitting dedicated pilot and data signal components is the need to share/distribute the available power between them. Thus, in case e.g., the user is only interested in tracking the pilot signal component, a lower useful power is available to the user.

Hence, an improved radio signal device would be advantageous, and in particular a more efficient and/or reliable radio signal device for transmitting and/or receiving a radio signal comprising the benefits of both pilot and data signals would be advantageous.

### OBJECT OF THE INVENTION

It is an object of the present invention to provide a radio signal device for transmitting a radio signal that enables simultaneous transmission of signal features, the signal features typical comprises pilot signal components and data signal components.

It is also an object of the present invention to provide a radio signal device for receiving the radio signal and the simultaneous exploitation of the radio signal as pilot signal component and data signal component.

It is a further object of the present invention to provide an alternative to the prior art.

In particular, it may be seen as an object of the present invention to provide a radio signal device that solves the above mentioned problems of the prior art with having to share/distribute the available power between the pilot signals components and data signal components.

### SUMMARY OF THE INVENTION

Thus, the above-described object and several other objects are intended to be obtained in a first aspect of the invention by providing a radio signal device adapted for transmitting a radio signal, wherein the transmitted radio signal z(k,t) comprises at least a block,
wherein the block comprises a pilot symbol d, the pilot symbol d comprises a plurality of pilot symbol components dᵢ, and a data symbol sₖ, the data symbol sₖ comprises a plurality of elements s_{k,i}; the radio signal device is adapted to generate the radio signal z(k,t) by:
   a. modulate the plurality of pilot symbol components dᵢ by a plurality of spreading code sequences cᵢ(t), which result is then modulated by a plurality of carrier waves sᵢ(t) to generate the baseline frequency components bᵢ(t), which are forming a baseline multi-carrier pilot signal b(t),
   b. select a data symbol sₖ depending on an index k, wherein the index k represents the information to be transmitted by the block,
   c. modulate the baseline multi-carrier pilot signal b(t) with the data symbol sₖ, such that each baseline frequency component bᵢ(t) is multiplied by the corresponding i-th element s_{k,i} of the data symbol sₖ generating a plurality of modulated frequency components zᵢ(t), and
   d. transmit the radio signal z(k,t) comprising the block, which is comprising the plurality of pilot symbol components dᵢ and the data symbol sₖ.

The radio signal device is adapted for transmitting a radio signal. The radio signal is transmitted in blocks and each block comprises a data symbol sₖ, which is a complex sequence. The data symbol sₖ is carrying the information transmitted in the signal. The data symbol sₖ is selected for block depending on the index k. The index k applied depends on the information transmitted in the block. The multi-carrier pilot signal b(t) is modulated by the data symbol sₖ to obtain the radio signal z(k,t) to be transmitted carrying both the pilot signal components and data signal components.

The index k represents the information to be transmitted in a block. The index k is the index selecting which data symbol sₖ is used for the data symbol sₖ, and thereby which information is transmitted in the block. The index k is an integral number. The integral number is corresponding to a piece of information transmitted in the block. The index k may be the information, such that the information transmitted in a block is the number of the index k. The information may be the number itself, or the number may be coded information for instance a character or a reference to a predefined message.

A block is a transmission sequence having a predetermined duration of a period Y. During the period Y, the block is transmitted. The transmission duration period Y may vary depending on what information is transmitted during the block, specific the period may vary depending in the index k.

“A block” is to be understood as a certain block of possible several blocks to be transmitted. The certain block may be any of the blocks to be transmitted.

The radio signal device adapted for transmitting a radio signal may in this document alternatively be called the transmitting radio signal device or the transmitter.

The pilot symbol d comprises a plurality of F pilot symbol binary components dᵢ, resulting in a modulation scheme of_{2F} symbols. The pilot symbols d applied in the multi-carrier pilot signal b(t) are known by the transmitter and receiver devices to ease the synchronization among them. F is an integer, and each pilot symbol component dᵢ is binary, 0 or 1.

The baseline multi-carrier pilot signal b(t) is generated by modulating a plurality of pilot symbol dᵢ components by a plurality of spreading code sequences cᵢ(t), which result is then modulated by a plurality of carrier waves sᵢ(t) to generate the baseline frequency components bᵢ(t). The multi-carrier frequency components bᵢ(t) forms the multi-carrier pilot signal b(t).

The plurality of carrier waves sᵢ(t) are of the form e(j_{ωi}t), with j the imaginary unit and ωᵢ the angular frequency ωᵢ=2πfᵢ, with fᵢ the carrier frequency. The baseline multi-carrier pilot signal b(t) comprises F frequency components, where F is an integer. For each of the F frequency components, a carrier wave sᵢ(t) at a certain carrier frequency fᵢ is used.

Each of the plurality of carrier waves sᵢ(t) is modulated by a spreading code sequence cᵢ(t) to generate the baseline frequency components bᵢ(t).

The data symbol sₖ is a vector carrying the information of the signal. The data symbol sₖ is a complex sequence. The data symbol sₖ is chosen depending on the index k. Each multi-carrier frequency component bᵢ(t) of the multi-carrier pilot signal b(t) is modulated by the i-th element s_{k,i} of the data symbol sₖ generating the plurality of modulated frequency components zᵢ(t), zᵢ(t)=s_{k,i}bᵢ(t).

The spreading code sequence cᵢ(t) comprises a deterministic binary sequence of pulses, commonly referred to as chips, a-priori-known by transmitter and receiver. Therefore, both the transmitter and the receiver are using the same spreading code sequence cᵢ(t) to modulate and demodulate the signal. The sequence cᵢ(t) resembles statistically a random sequence thus being difficult to predict. Such sequence may be generated using an algorithm known a priori by transmitter and receiver or may be generated in advanced and loaded in both transmitter and receiver devices.

The invention is particularly, but not exclusively, advantageous for obtaining that the radio device is simultaneous transmitting the pilot symbol components dᵢ and data symbols sₖ components modulated on the same transmission while not sharing/distributing the available power between them.

In a second aspect, of the invention provides a radio signal device adapted for receiving and synchronising a radio signal, wherein a received radio signal r(t) comprises a plurality of signal components rᵢ(t) in at least a block, and the block comprises a data symbol sₖ, the data symbol sₖ comprises a plurality of elements sₖ, depending on an index k; the received radio signal r(t) being transmitted from a transmitting radio signal device transmitting a radio signal z(k,t); the transmitting radio signal device before transmitting the radio signal z(k,t)
modulates a plurality of pilot symbol components dᵢ by a plurality of spreading code sequences cᵢ(t), which result then being modulated by a plurality of carrier waves sᵢ(t) to generate the baseline frequency components bᵢ(t), which are forming a baseline multi-carrier pilot signal b(t), and
modulates the baseline multi-carrier pilot signal b(t) with the data symbol sₖ, such that each baseline frequency component bᵢ(t) is multiplied by the corresponding i-th element s_{k,i} of the data symbol sₖ generating a plurality of modulated frequency components zᵢ(t);
then the transmitting radio signal device transmits the radio signal z(k,t) comprising the block, which is comprising the plurality of pilot symbol components dᵢ and the data symbol sₖ;
the radio signal device adapted for receiving the radio signal r(t), after receiving the radio signal r(t), is adapted to determine the index k of the data symbol sₖ of the received block, by:
   a. demodulate each of the signal components rᵢ(t) with the carrier wave sᵢ(t) and the spreading code sequence cᵢ(t) to obtain a Cross-Ambiguity Function (CAF) Y_{k,i} of each signal component,
   b. obtain an overall CAF Ωₖ by combining the CAFs Y_{k,i}, of each signal component,
   c. detect local maximums above a threshold λ(P_{FA}) of the phase lag dimension p of the overall CAF Ωₖ,
   d. determine the index k of the data symbol sₖ of the received block based on the detected local maximums and the distance between the local maximums in the phase lag dimension p.

The transmitted radio signal z(k,t) is generated and transmitted by one radio signal device, and another radio signal device adapted for receiving the radio signal receives the radio signal r(t). The radio signal z(k,t) transmitted by the transmitting radio signal device according to the first aspect of the invention, may be received and demodulated by a plurality of radio signal devices adapted for receiving a radio signal. The received radio signal r(t) will differ from the transmitted radio signal z(k,t) due to distortion during the transmission. The radio signal will be distorted during transmission by for example noise and Doppler effect.

The radio signal device adapted for receiving a radio signal may in this document alternatively be called the receiving radio signal device or the receiver.

When receiving the radio signal the receiving radio signal device will decode the signal to determine the index k contained in each block of the radio signal. Also, the receiving radio signal device may decode the plurality of pilot symbol components dᵢ to determine the identity and location of the transmitting radio signal device.

A block may be a received block or a transmitted block. When the block is received is to be understood as one of the blocks received by the radio signal device adapted for receiving and synchronising a radio signal. The received block may be any of the blocks received.

Decoding the radio signal is done by correlating the received radio signal r(t), which comprises the plurality of signal components rᵢ(t), with the carrier waves sᵢ(t) and the spreading code sequences cᵢ(t). The receiver knows the subcarrier frequencies ωᵢ and the spreading code sequences a-priori. In this case, when demodulating, the plurality of carrier waves sᵢ(t) are of the form e(−jωᵢt). This process of demodulating the radio signal by using the carrier waves sᵢ(t) and the spreading code sequences cᵢ(t) is also referred to as using a matched filter. The matched filter is applied to the received signal, whereby the receiver can determine whether the transmitted signal contains any content relevant for the receiver.

A CAF Y_{k,i} is obtained for each signal component that depends on the received signal time (τ) and frequency (ν) errors. The CAF Y_{k,i} are then combined to obtain an overall CAF Ωₖ which also depends on the phase (φ among individual CAF. The CAF depends on the characteristics of the spreading code sequence cᵢ(t) and represents the impact of propagation on the signal in terms of time, phase and frequency.

The overall CAF Ωₖ comprises time lag, frequency lag and phase lag dimensions. The phase lag dimension is a function of the frequency of the transmitted signal components, showing the amplitude of the phase lag as a function of the phase between individual subcarriers. In this spectrum there may be two, or more, local maximums, which are correlation peaks. The local maximums are identified and a data symbol sₖ is demodulated, determining the index k, by the distance between the local maximum. A local maximum in the phase lag may be detected by finding the amplitudes larger than a threshold value λ(P_{FA}).

The terms “peak” and “local maximum” is used interchangeable in this document.

The proposed concept may be applied to GNSS signals, or any other system in general, based on Multi-Carrier (MC) frequency components that need to serve the roles of both pilot and data components at the same time, such that
the receiver can choose in a flexible way the coherent integration period used in the detection/acquisition of the signal (from short to long periods); and
enabling the transmission and reception of data in short periods of time, from few milliseconds (ms), and the flexible data demodulation, with shorter or longer processing times, depending on the channel and receiver conditions.

According to an embodiment, an integration period T to generate the overall CAF Ωₖ is less than or equal to a duration time Y of transmitting the block.

The transmitter transmits the block in a duration time Y. However, when the receiver receives the signal it may not need to receive the entire block to be able to generate the overall CAF Ωₖ.

In the phase lag dimension p, a local maximum may be determined when the amplitude of the phase lag is larger than a threshold value λ(P_{FA}). Based on the locations of the local maximums and the distance between the local maximum, the data symbol corresponding to the data symbol sₖ may be identified. At least one local maximum in the phase lag dimension p of the overall CAF Ωₖ is applied in the determination of the index k.

By having an integration period T less than or equal to a duration time Y of transmitting a block to generate the overall CAF Ωₖ the receiver may use less power to determine the index k for the transmitted block and demodulate and synchronize with the signal faster and by using less power.

According to an embodiment to retrieve the data symbol sₖ, the generation of the overall CAF Ωₖ is performed in an integration period T below or equal to the duration time Y of transmitting the block, with the number of samples, and the range covered in the time lag, angular frequency lag, and the phase lag dimensions being selected depending on the receiver operating conditions.

If the conditions for receiving the transmitted signal are good, the receiver may be able to determine the overall CAF Ωₖ from only a small part of the transmitted block and may therefore only receive a small part of the block to identify the data symbol corresponding to the data symbol sₖ and determine the index k.

According to an embodiment the two or more local maximums are detected in the phase lag dimension of the overall CAF Ωₖ generated, with the number of local maximums to be detected depends on the data symbol sₖ.

In the phase lag dimension of the overall CAF Ωₖ two or more local maximums are detected.

According to an embodiment, the index k is determined as a function of the estimated relative distance between the set of local maximums detected.

The number of local maximums and the distance between the local maximums depend on the data symbol sₖ. Therefore, the distance between the local maximums may be used to determine which data symbol sₖ was applied to generate the signal and thereby the receiver may determine the data symbol sₖ applied and thereby determine the index k.

According to an embodiment the blocks are transmitted consecutively, one after the other, forming a continuous signal.

Blocks may be transmitted consecutively, so the next block is transmitted just after the previous transmitted block.

According to an embodiment, the blocks are transmitted in snapshots at any arbitrary time and/or with a certain duty-cycle.

A block may be transmitted at any time in a snapshot. Alternatively, a block may be transmitted in a certain duty-cycle. A certain duty-cycle is a duty-cycle with a fixed period between transmitting the previous block and the next block.

According to an embodiment, the duration time Y of transmitting a block is varying.

The duration time of transmitting a block may be varying. It may depend on the data transmitted. For instance, the duration time Y of transmitting a block may depend on the data symbol transmitted, for instance depending on the index k of the data symbol corresponding to the data symbol sₖ.

According to an embodiment the data symbol sₖ is a vector comprising a number of elements, each element is a function of the step-phase Δφ_{k,d} and/or the offset-phase φ_{0,k,d} and/or the global-step-phase Δθ_{k,d}.

The step-phase Δφ_{k,d} and the offset-phase φ_{0,k,d} are applied to the transmission of the data symbol. The usage of different step-phase Δφ_{k,d} results in different separations between the local maximums in the phase-lag dimension obtained when assessing the phase between individual CAF Y_{k,i} by combining them to obtain an overall CAF Ωₖ.

The step-phase Δφ_{k,d} is applied to defining the distance between of the local maximums.

The global-step-phase Δθ_{k,d} is applied to offsetting the location of all the local maximums.

According to an embodiment the data symbol sₖ is a vector comprising a number of elements s_{k,i}, where the i-th element is defined as

$${s}_{k , i} = {\sum }_{d = 1}^{D} {p}_{d} \cdot exp \{ j ( i - 1 ) {Δθ}_{k , d} \} \cdot f ( exp \{ j [ ( 1 - i ) {Δφ}_{k , d} + {φ}_{0 , k , d} ] \} )$$

where
   D≥1 and determines the number of step-phases Δφ_{k,d}

$${\sum }_{d = 1}^{D} {p}_{d} = 1 ,$$

k is the index k of the data symbol sₖ,
the function f(x) is defined as f(x)=Re(x), or f(x)=Im(x), or f(x)=g(Re(x)), or f(x)=g(Im(x)), with g(x) a pass-band filter, and
Δφ_{k,d} and φ_{0,k,d}, are respectively the step-phase and the offset-phase applied to the transmission of the data symbol,
Δθ_{k,d} is the global-step-phase applied to offsetting the location of all the local maximums.

D corresponds to the number of individual step-phases present in the data symbol sₖ. As example, D may be set to 1 resulting in two different peaks in the CAF when f(x)=g(Re(x)) or f(x)=g(Im(x)).

According to an embodiment the CAF Y_{k,i} of each signal component is obtained by

$${{Υ}_{k , i}}_{} ( τ , v ) = {\int }_{0}^{T} {B}_{i} ( {r}_{k} ( t ) ) {b}_{i}^{*} ( t - τ ) exp \{ jvt \} dt ,$$

wherein r(t) is the received radio signal, Bᵢ( ) is a band-pass filtering function, bᵢ* is the complex conjugated baseline frequency component, T is the integration period, τ is the time lag, u is the angular frequency lag, and k is the index of the data symbol sₖ and j is the imaginary unit.

The CAF Y_{k,i} represents the dispersion of the i-th component in time and frequency after applying the receiver matched filter.

According to an embodiment the overall CAF is obtained by

$${Ω}_{k} ( τ , v , ρ ) = {\sum }_{i = 1}^{F} {{Υ}_{k , i}}_{} ( τ , v ) exp \{ j ρ i \} ,$$

wherein F is is the number of frequency components, τ is the time lag, ν is the angular frequency lag, ρ is the phase lag, k is the index of the data symbol sₖ, and j is the imaginary unit.

The overall CAF comprises a phase lag dimension p, from which local maximum may be determined and from the distances between the local maximum, the data symbol sₖ applied to modulate the data symbol in the transmitted signal, can be determined and thereby the index k can be determined to reveal the information transmitted and received.

The acquisition of the received multi-carrier signal is based on the derivation of the overall CAF by the receiver. The derivation of the overall CAF may be implemented following different receiver architectures in which correlators and/or Fast Fourier Transforms (FFT) are used for performing correlation operations for certain integration periods. The usage of an FFT-based correlation [5] may allow to reduce the number of operations required with respect to the usage of correlators. The usage of FFT-based stages may be used to integrate correlation contributions from different carrier frequencies. The derivation of the overall CAF will in general require the application of filtering operations (to attenuate or reject certain frequency bands of the received signal), down-conversion operations (to convert the received signal to a lower-frequency signal, possibly to derive a base-band signal centred around zero frequency, or near-zero frequency), and Doppler-removal operations (to remove the frequency offset introduced by Doppler effects, allowing to derive a base-band signal centred around zero-frequency).

In radio communication and signal processing, a baseband signal refers to a signal that has not been modulated to a higher frequency for transmission a communication channel.

According to an embodiment, the acquisition of the received multi-carrier signal r(t) is performed by using the following receiver architecture:
a) a filtering and down-conversion stage to convert to base-band the signal component rᵢ(t) in each carrier frequency fᵢ using the corresponding carrier wave sᵢ(t);
b) a correlator-based stage to remove the Doppler frequency of the received radio signal r(t);
c) an FFT-based correlation stage of each of the resulting base-band signal per carrier frequency fᵢ with the corresponding spreading code sequence cᵢ(t);
d) an FFT-based integration stage of the correlation contributions of all the carrier frequencies fᵢ; and
e) a detection stage of the local maximum or local maximums above a threshold λ(P_{FA}).

The spreading code sequence cᵢ(t) use by the pilot symbol dᵢ may be built based on so-called primary spreading codes (or primary codes) with a certain code length. The usage of short code lengths for the primary spreading codes may be of interest to reduce the number of operations required in the acquisition of the received multi-carrier signal. Primary spreading codes with a code length equal or below 1023 binary pulses (so-called chips) may be of interest, including code lengths of hundreds of chips (for example, between 300 and 400 chips), and/or tens of chips (for example, between 20 and 40 chips).

According to an embodiment, the multi-carrier pilot signal b(t) is generated based on the usage of an arbitrary short primary spreading code sequence cₛₕₒᵣₜ(t), with the code length of the primary spreading code sequence equal or below 1023 binary pulses, being the short primary spreading code sequence transmitted in a single carrier frequency fᵢ during a certain time period D, such that the same short primary spreading code sequence cₛₕₒᵣₜ(t) is transmitted one or multiple times consecutively during the time period D, until the same primary spreading code sequence cₛₕₒᵣₜ(t) is transmitted in a different carrier frequency fᵢ, forming a short-code frequency-hopping (SC-FH) multi-carrier signal.

The signal structure of the short-code frequency-hopping (SC-FH) multi-carrier signal allows to simplify the receiver architecture used for the acquisition, and to reduce the number of operations required in the acquisition process. After acquisition, the SC-FH multi-carrier signal may be tracked for the derivation of so-called code pseudorange estimations. The accuracy of the code pseudorange estimations will depend on the total bandwidth of the SC-FH multi-carrier signal. Therefore, the short-code frequency-hopping (SC-FH) multi-carrier signal may be used to perform in parallel low-complexity acquisition and accurate pseudorange estimation (i.e., tracking) processes, without the need to have dedicated signals for each purpose.

According to an embodiment, the acquisition of the short-code frequency-hopping (SC-FH) multi-carrier pilot signal b(t) is performed by using the following receiver architecture
a) a correlator-based stage to remove the Doppler frequency of the received multi-carrier signal;
b) a decimation, i.e. down-sampling, stage to generate an equivalent base-band signal, with a down-sampling frequency equal or below to the bandwidth of the short primary spreading code sequence cₛₕₒᵣₜ(t) transmitted in each carrier frequency fᵢ;
c) an FFT-based correlation stage with the replica of the short primary spreading code sequence cₛₕₒᵣₜ(t); and
d) a detection of the local maximum above a threshold λ(P_{FA}). in the code-delay dimension.

According to an embodiment, the multi-carrier pilot signal b(t) is an orthogonal frequency-division multiplexing (OFDM) signal.

According to an embodiment, the multi-carrier pilot signal b(t) is a frequency-hopping spread spectrum (FHSS) signal.

According to an embodiment, multiple multi-carrier pilot signals b(t) are transmitted in parallel in multiple frequency bands.

According to an embodiment, the radio signal is used in a Global Navigation Satellite System (GNSS).

According to an embodiment, the radio signal is used based on a Medium-Earth Orbit (MEO), Low-Earth-Orbit (LEO) and/or Geosynchronous Equatorial Orbit (GEO) satellite constellation.

According to an embodiment, the signal detection and/or data symbol retrieval comprises the detection and/or estimation of one or multiple local maximums from one or multiple radio signals received from different satellites for the exploitation of spatial diversity.

The radio signal device for receiving a radio signal may be able to receive signals from different transmitters.

The proposed concept can work either in cold start or with some a priori information being available e.g., assistance, which would enable to reduce the acquisition search space in the frequency domain, and possibly also in the time. Additionally, if the receiver is in tracking-like conditions, e.g., operating in continuous or duty-cycling mode, knowing very well the time/frequency, the number of correlation points needed in the time/frequency domains can be few in order to keep tracking, as in standard GNSS receivers, and the phase lag dimension is to be assessed, if needed, to retrieve the current data symbol sₖ being transmitted.

The proposed concept allows direct snapshot processing, i.e., performing both acquisition and data demodulation in the same shot, and for a very short snapshot.

Additionally, the proposed concept gives full flexibility to the receiver to:
a) decide the snapshot length that wants to exploit e.g., depending on the environment it operates,
b) decide to exploit the signal component only for detection/acquisition and/or tracking, if not interested in the data provided, or
c) decide to exploit the signal component for both detection/acquisition and fast retrieval of data also with a flexible snapshot length. This allows the receiver to get any type of information of interest at the beginning of operation together with the acquisition with a very short latency, even when operating in snapshot mode i.e., without the need to go to continuous tracking or to track/demodulate the signal for a longer period if this is not of interest for the receiver.

It is also noted that the proposed concept is fully compatible with the typical phase miss-alignments expected in practice between the multiple carriers, e.g., introduced by receiver front-end distortions or atmospheric effects. Indeed, the exploitation of the phase lag dimension allows to deal with this type of effects, and at the same time is useful to retrieve information with the proposed concept.

The exploitation of multi-carrier signals for positioning has been considered in the literature due to the improved code accuracy achieved with the code pseudorange estimations (including multipath conditions) and the improved robustness to the operation in frequency selective fading channel conditions. Multi-carrier signals may also be composed by both pilot and data signal components.

A MC pilot signal facilitates acquisition and tracking operations at receiver level; while a MC data signal enables the dissemination of data (typically, aided by the pilot tracking). Pilot and data signals may be transmitted in parallel.

The proposed signal concept:
a) is based on the exploitation of signals composed by multiple frequency components, i.e., multi-carrier (MC) signals,
b) enables the transmission of data in short periods of time (from few ms),
c) while enabling at the same time its flexible usage as a pilot signal for detection with both short (few ms) and long (up to hundreds of ms) coherent integration times, depending on the user receiver needs, and
d) is compatible with both continuous and snapshot operation modes.

Thus, a single MC signal exploiting the proposed signal concept can be applied both as pilot and data components, without the need of sharing the power in two separate signal components.

In a third aspect the invention relates to a method for transmitting a radio signal for a radio signal device, wherein the transmitted radio signal z(k,t) comprises at least a block,
wherein the block comprises a pilot symbol d, the pilot symbol d comprises a plurality of pilot symbol components dᵢ, and a data symbol sₖ, the data symbol sₖ comprises a plurality of elements sₖ,i; the radio signal device is adapted to generate the radio signal z(k,t) by:
   a. Modulating the plurality of pilot symbol components dᵢ by a plurality of spreading code sequences cᵢ(t), which result is then modulated by a plurality of carrier waves sᵢ(t) to generate the baseline frequency components bᵢ(t), which are forming a baseline multi-carrier pilot signal b(t),
   b. selecting a data symbol sₖ depending on an index k, wherein the index k represents the information to be transmitted by the block,
   c. modulating the baseline multi-carrier pilot signal b(t) with the data symbol sₖ, such that each baseline frequency component bᵢ(t) is multiplied by the corresponding i-th element s_{k,i} of the data symbol sₖ generating a plurality of modulated frequency components zᵢ(t), and
   d. transmitting the radio signal z(k,t) comprising the block, which is comprising the plurality of pilot symbol components dᵢ and the data symbol sₖ.

In a fourth aspect the invention relates to a method for receiving and synchronising a radio signal by a radio signal device, wherein a received radio signal r(t) comprises a plurality of signal components rᵢ(t) in at least a block, and the block comprises a data symbol sₖ, the data symbol sₖ comprises a plurality of elements s_{k,i} depending on an index k; the received radio signal r(t) being transmitted from a transmitting radio signal device transmitting a radio signal z(k,t);
the transmitting radio signal device, before transmitting the radio signal z(k,t),
   modulates a plurality of pilot symbol components dᵢ by a plurality of spreading code sequences cᵢ(t), which result then being modulated by a plurality of carrier waves sᵢ(t) to generate the baseline frequency components bᵢ(t), which are forming a baseline multi-carrier pilot signal b(t), and
modulates the baseline multi-carrier pilot signal b(t) with the data symbol sₖ, such that each baseline frequency component bᵢ(t) is multiplied by the corresponding i-th element s_{k,i} of the data symbol sₖ generating a plurality of modulated frequency components zᵢ(t); then the transmitting radio signal device transmits the radio signal z(k,t) comprising the at least one block, which is comprising the plurality of pilot symbol components dᵢ and the data symbol sₖ;
the radio signal device (4) adapted for receiving the radio signal, after receiving the radio signal r(t), is adapted to determine the index k of the data symbol sₖ of the received block, by:
   a. demodulating each of the signal components rᵢ(t) with the carrier wave sᵢ(t) and the spreading code sequence cᵢ(t) to obtain a Cross-Ambiguity Function (CAF) Y_{k,i} of each signal component,
   b. obtaining an overall CAF Ωₖ by combining the CAFs Y_{k,i},of each signal component,
   c. detecting local maximums above a threshold λ(P_{FA}) of the phase lag dimension ρ of the overall CAF Ωₖ,
   d. determining the index k of the data symbol sₖ of the received block based on the detected local maximums and the distance between the local maximums in the phase lag dimension ρ.

The individual aspects of the present invention may each be combined with any of the other aspects. These and other aspects of the invention will be apparent from the following description with reference to the described embodiments.

### BRIEF DESCRIPTION OF THE FIGURES

The radio signal device according to the invention will now be described in more detail with regard to the accompanying figures. The figures show one way of implementing the present invention and is not to be construed as being limiting to other possible embodiments falling within the scope of the attached claim set.

FIG. 1 schematically illustrates a radio system.

FIG. 2 is a two high-level block diagram showing the data flow.

FIG. 3 illustrates a baseline multi-carrier pilot signal b(t) comprising multiple frequency components bᵢ(t).

FIGS. 4a and 4b illustrates the frequency components bᵢ(t).

FIG. 5a illustrates that each of the frequency components bᵢ(t) is modulated with the complex sequence of the data symbol sₖ.

FIG. 5b illustrates two radio signal blocks bₖ₁(t) and bₖ₂(t) comprising signal components at different frequencies ω₁-ω_{F}.

FIG. 6 illustrates the MC pilot symbol components dᵢ being modulated with the spreading code sequence cᵢ(t).

FIG. 7 illustrates the MC pilot symbol components dᵢ being modulated with the data symbol sₖ.

FIG. 8 illustrates that the radio signal is transmitted in blocks with a duration of Y ms.

FIG. 9 illustrates the flexibility to process short or long snapshots of the signals for detection and symbol estimation.

FIG. 10 is an illustration of local maximums, which are correlation peaks, observed in the phase lag dimension.

FIG. 11 is illustrating how the peaks or local maximums are counted.

FIG. 12 illustrates a receiver architecture using down-conversion, Doppler removal and correlation.

FIG. 13 illustrates a receiver architecture for the short-code frequency-hopping (SC-FH) multi-carrier signal, using decimation and FFT-based correlation.

FIG. 14 illustrates the method for transmitting a radio signal.

FIG. 15 illustrates the method for receiving and synchronising a radio signal.

### DETAILED DESCRIPTION OF AN EMBODIMENT

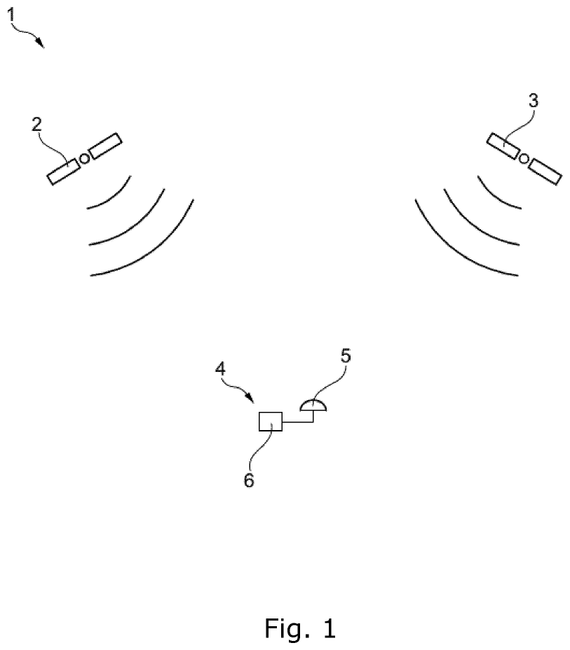

FIG. 1 schematically illustrates a radio system 1, here in the form of a GNSS, comprising a first radio signal device 2 and a second radio signal device 3, both adapted for transmitting a radio signal (called transmitters in the following). The two transmitters 2, 3 are mounted on satellites in this case, but may in other types of radio system be e.g., terrestrial. The radio system 1 further comprises a third radio signal device 4 adapted for receiving the radio signal from the transmitters via an antenna 5, for further signal processing in a receiving unit 6.

The present invention relates to a radio signal, and the devices and methods required for its transmission and/or reception.

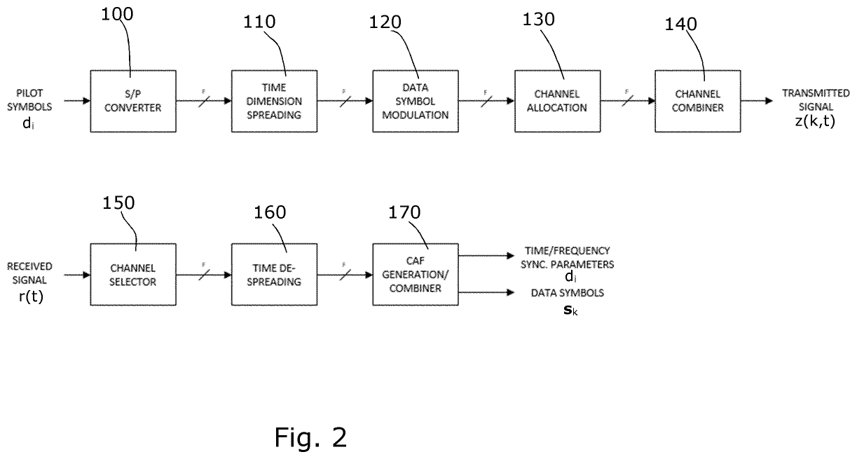

FIG. 2 is a two high level-block diagram showing the data flow. Pilot symbol components dᵢ enters the Serial/Parallel (S/P) converter 100 for their later parallel processing, and then in step 110 the pilot symbol components dᵢ are modulated by a plurality of spreading code sequences cᵢ(t), then in step 120 the result is modulated by the data symbol sₖ, then in channel allocation 130 the result is modulated by a plurality of carrier waves sᵢ(t), and in channel combiner 140 the result is combined before the signal is transmitted.

In the lower block diagram, the radio signal r(t) is received in the channel selector 150, and in step 160 each signal component rᵢ(t) is correlated with the spreading code sequence cᵢ(t) to obtain a CAF of each signal component. In step 170, the CAFs are combined to obtain the overall CAF, and data symbols sₖ are detected together with time/frequency synchronization parameters.

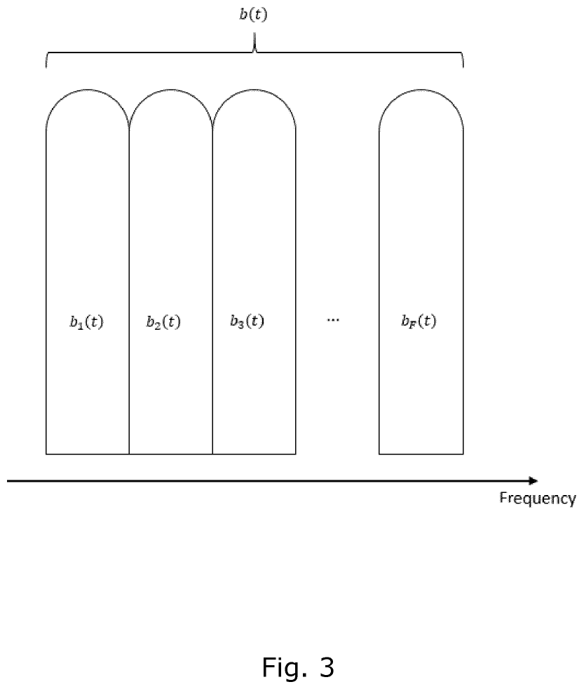

FIG. 3 illustrates a baseline multi-carrier pilot signal b(t) comprising multiple frequency components bᵢ(t). The multi-carrier signal is comprising F orthogonal frequency components bᵢ(t), where F is an integer number and F≥2, each of them transmitted at different carrier frequencies, being the i-th frequency component bᵢ(t), which has been modulated by an a-priori-known spreading code sequence cᵢ(t), forming the baseline multi-carrier (MC) pilot signal b(t); FIG. 3 illustrates the frequency components b₁(t), b₂(t), b₃(t) to b_{F}(t), where each frequency components is centered around a different frequency.

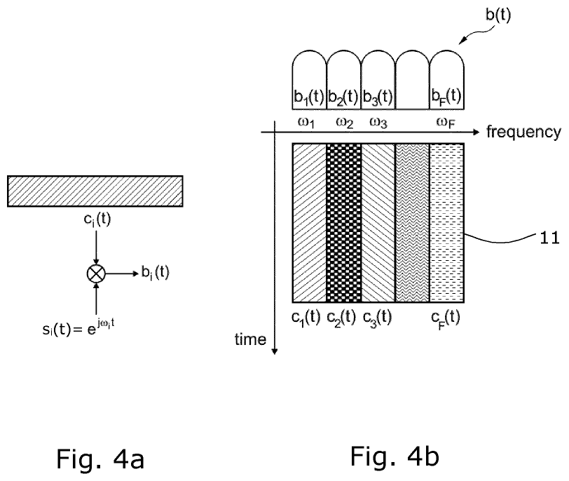

FIG. 4a illustrates obtaining of the frequency components bᵢ(t) by multiplying a carrier wave sᵢ(t)=e(jωᵢt) by a spreading code sequence cᵢ(t). In this illustration dᵢ is omitted (considered dᵢ equal to 1).

FIG. 4b illustrates that the plurality of frequency components bᵢ(t) are forming a baseline multi-carrier pilot signal b(t), with each frequency component centered around a different frequency ωᵢ. Each spreading code sequence cᵢ(t) has a duration equal or shorter than the duration of a block 11. On the latter, successive spreading codes are applied to form a block. Without loss of generality, an infinite non-repetitive spreading code sequence could extend along different blocks, virtually assigning a different spreading code sequence to each block.

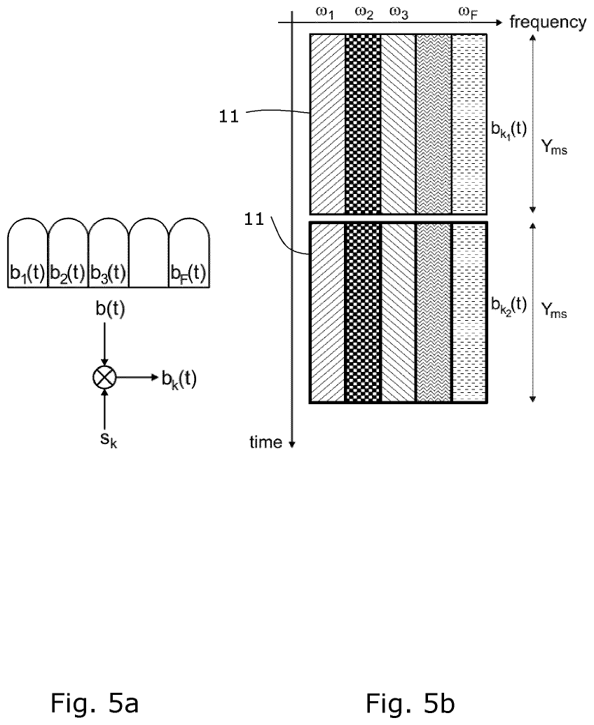

FIG. 5a illustrates that each of the frequency components bᵢ(t) is modulated with the complex sequence of the data symbol sₖ, which is a vector and k is the index of the data symbol. The i-th frequency components bᵢ(t) is modulated by the i-th component of the data symbol sₖ resulting in the frequency component zᵢ(t), to obtain the radio signal z(k,t) to be transmitted.

FIG. 5b illustrates two radio signal blocks bₖ₁(t) and bₖ₂(t) comprising signal components at different frequencies ωᵢ-ω_{F}. Each block 11 has a duration of Y ms.

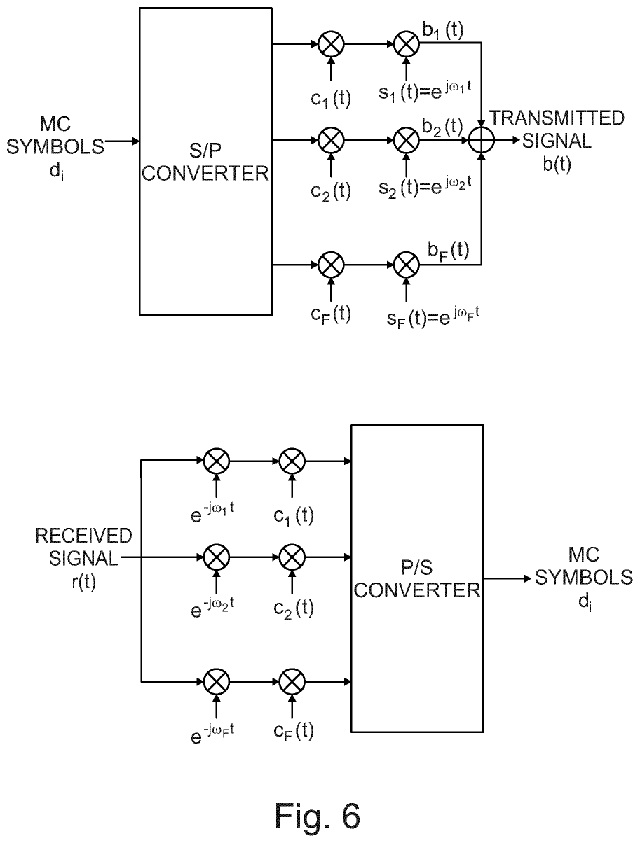

FIG. 6 illustrates the MC pilot symbol components dᵢ being modulated by the spreading code sequence cᵢ(t), illustrated by c₁(t), c₂(t) and c_{F}(t) and the carrier wave sᵢ(t)=e(jωᵢt), illustrated by e(jωᵢt), e(jω₂t) and e(jω_{F}t), but not with the data symbol sₖ. In this situation no data is transmitted, only the pilot symbol components dᵢ.

In the receiver the received radio signal r(t) is correlated with the spreading code sequences cᵢ(t) and the carrier waves e(−jωᵢt), which are known to the receiver, to obtain the pilot symbol components dᵢ.

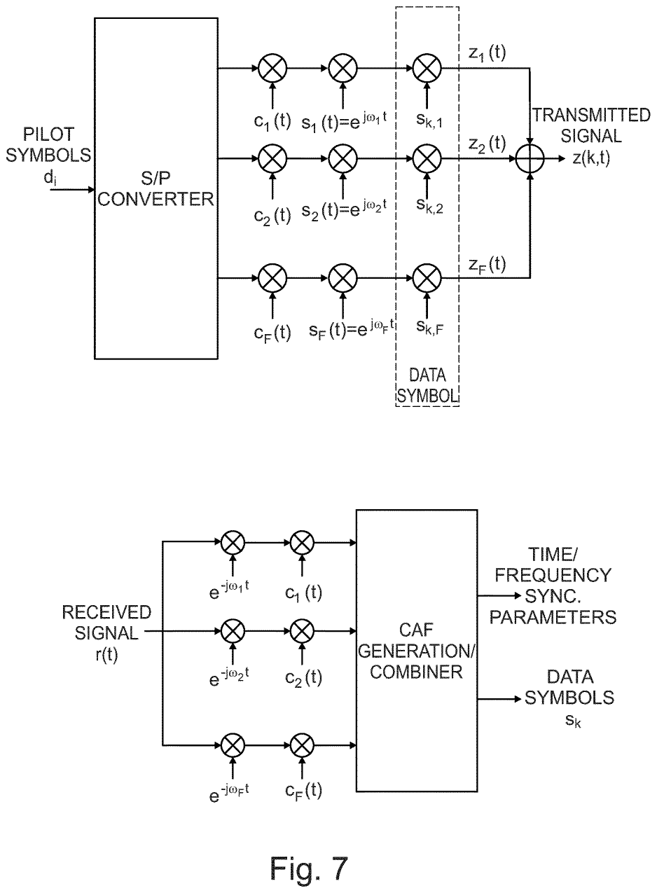

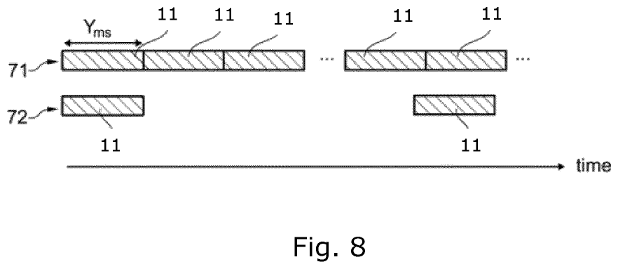

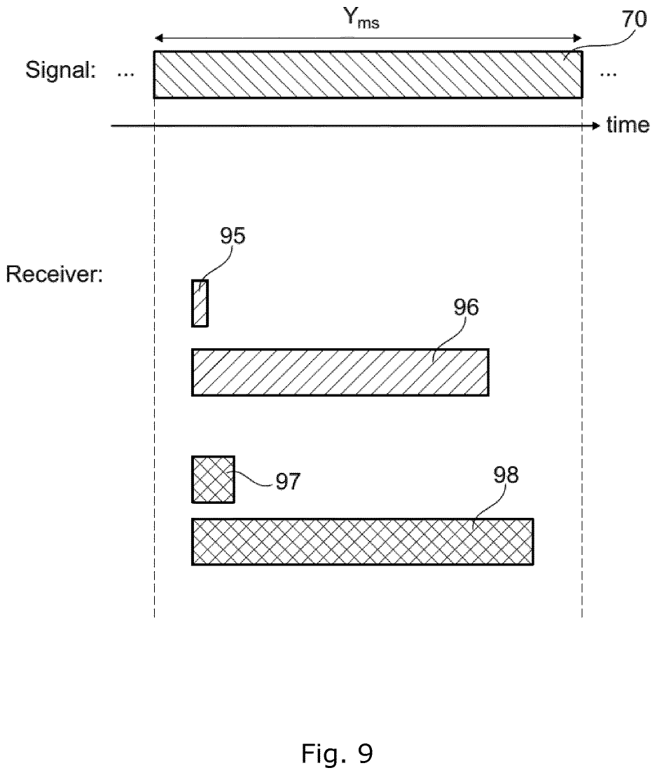

FIG. 7 illustrates the MC pilot symbol components dᵢ being modulated by the spreading code sequence cᵢ(t), illustrated by c₁(t), c₂(t) and c_{F}(t), the carrier wave sᵢ(t)=e(jωᵢt), illustrated by e(jωᵢt), e(jω₂t) and e(jω_{F}t), and the data symbol sₖ, illustrated by s_{k,1}, s_{k,2}, s_{k,F}, to form the modulated frequency components zᵢ(t), illustrated by z₁(t), z₂(t) and z_{F}(t). The modulated frequency components are forming the transmitted radio signal z(k,t) and is transmitted to the receiver. The transmitted radio signal in this situation carries information used for location and identifying the satellite and also carries information of the data symbol sₖ.

In the receiver the received radio signal r(t) is correlated with the spreading code sequences cᵢ(t) and the carrier waves e(−jωᵢt), which are known to the receiver, to obtain the data symbol sₖ.

### Derivation of the Signal Concept

The complex base-band representation of the baseline multi-carrier pilot signal b(t) may be modeled as follows:

$$b ( t ) = {\sum }_{i = 1}^{F} {b}_{i} ( t ) = {\sum }_{i = 1}^{F} {a}_{i} {c}_{i} ( t ) exp \{ k {ω}_{i} t \} \qquad ( 1 )$$

where F is the number of frequency components of the baseline multi-carrier pilot signal b(t), with frequency component bᵢ(t) the i-th component of the multi-carrier pilot signal b(t), and aᵢ, cᵢ(t), and ωᵢ are the complex amplitude, the a-priori-known spreading code sequence, and the angular frequency, respectively, for the i-th component of the multi-carrier pilot signal b(t). Throughout this document, j is the imaginary unit.

### Defining the Vector sₖ

$${s}_{k} = {[ \begin{matrix}{s}_{k , 1} & ⋯ & {s}_{k , F}\end{matrix} ]}^{T} ∈ {𝒞}^{F \times 1}$$

gathering the elements of the data symbol sₖ of the data symbol transmitted during Y ms, with the i-th element

$${[ {s}_{k} ]}_{i} {=}^{△} {s}_{k , i}$$

being defined as follows:

$${s}_{k , i} = {\sum }_{d = 1}^{D} {p}_{d} \cdot exp \{ j ( i - 1 ) {Δθ}_{k , d} \} \cdot f ( exp \{ j [ ( i - 1 ) {Δφ}_{k , d} + {φ}_{0 , k , d} ] \} ) \qquad ( 2 )$$

where

$$D \geq 1 ,$$

$${\sum }_{d = 1}^{D} {p}_{d} = 1 ,$$

the function f(x) is defined as f(x)=Re(x), or f(x)=Im(x), or f(x)=g(Re(x)), or f(x)=g(Im(x)), with g(x) a pass-band filter,
Δφ_{k,d} and φ_{0,k,d}, are the step-phase and the offset-phase, respectively, applied to the transmission of the data symbol,
Δθ_{k,d} is the global-step-phase applied to offsetting the location of all the local maximums.

Δφ_{k,d} is the step-phase, applied to defining the location of the local maximums. The usage of different Δφ_{k,d} results in different separations between the local maximums in the phase-lag dimension obtained when applying the matched filter of the multi-carrier pilot signal b(t) to the modulated signal z(k,t) signal modulated with the symbol sequence sₖ, as defined below.

Based on the previous definitions, the radio signal z(k,t) modulated with the data symbol sₖ for the transmission of the data symbol, is defined as follows:

$$z ( k , t ) = {\sum }_{i = 1}^{F} {s}_{k , i} {b}_{i} ( t ) \qquad ( 3 )$$

The signal z(k,t) is transmitted by the radio signal device adapted for transmitting a radio signal and is received by a radio signal device adapted for receiving a radio signal.

On the receiver side, the complex base-band representation of the received signal r(t) corresponding to the period of Y ms in which the data symbol corresponding to the data symbol sₖ is transmitted may be modelled in a simplified way as follows:

$$r ( t ) = {\sum }_{i = 1}^{F} {h}_{i} ( t ) exp \{ j {ω}_{o , i} t \} {a}_{i} {c}_{i} ( t - {τ}_{i} ( t ) ) exp \{ j ( {ω}_{i} t + {ϕ}_{k , i} ) \} + e ( t ) \qquad ( 4 )$$

where hᵢ, τᵢ, and ω_{o,i} are the complex amplitude, delay and angular frequency shift introduced by the channel for the i-th frequency component, Φ_{k,i} is the combined phase offset due to the delay z and symbol s_{k,i} and e models all other noise and interference components, including multipath, added to the signal of interest.

The receiver can now apply to the received signal r(t) the matched filter for the a-priori-known frequency components bᵢ(t) of the baseline multi-carrier pilot signal b(t) for the generation of a CAF per frequency component/band (Y_{k,i}(τ, ν)) as a first step for the generation of the overall CAF considering the complete received signal (Ωₖ(τ, ν, ρ)), with

$${{Υ}_{k , i}}_{} ( τ , v ) = {\int }_{0}^{T} {B}_{i} ( {r}_{k} ( t ) ) {b}_{i}^{*} ( t - τ ) exp \{ jvt \} dt , \qquad ( 5 )$$

$${Ω}_{k} ( τ , v , ρ ) = {\sum }_{i = 1}^{F} {{Υ}_{k , i}}_{} ( τ , v ) exp \{ j ρ i \} , \qquad ( 6 )$$

with τ the time lag, ν the angular frequency lag, and ρ the phase lag of the CAF generated; T the integration period considered, with T≤Y; and Bᵢ( ) is a band-pass filtering function centered at the i-th frequency component.

Based on the CAF for the range of time, frequency and phase lags of interest, a set of two or more local maximums, depending on the symbol sequence sₖ applied to modulating the baseline pilot signal, are to be detected in the phase lag dimension; a potential implementation approach is to detect first a first maximum, or the global maximum observed,

$$\{ {\hat{τ}}_{1} , {\hat{v}}_{1} , {\hat{ρ}}_{1} \} = arg {max}_{τ , v , ρ} \vert {Ω}_{k} ( τ , v , ρ ) \vert , \qquad ( 7 )$$

and then derive the other maximum/s, one or more, in the phase lag dimension ρ.

The relative distance between the local maximums will be dependent on the data symbol transmitted and the specific symbol sequence configuration applied, as per equation (2). For the particular case of D=1, f(x)=Re(x), φ_{0,k,1}=Δθ_{k,1}=0, and φ_{k,1}=2πk/F in equation (2) for the k-th symbol, with k an integer value between 1 and floor(F/2), a set of floor(F/2) relative distances are obtained, each of them corresponding to a different data symbol.

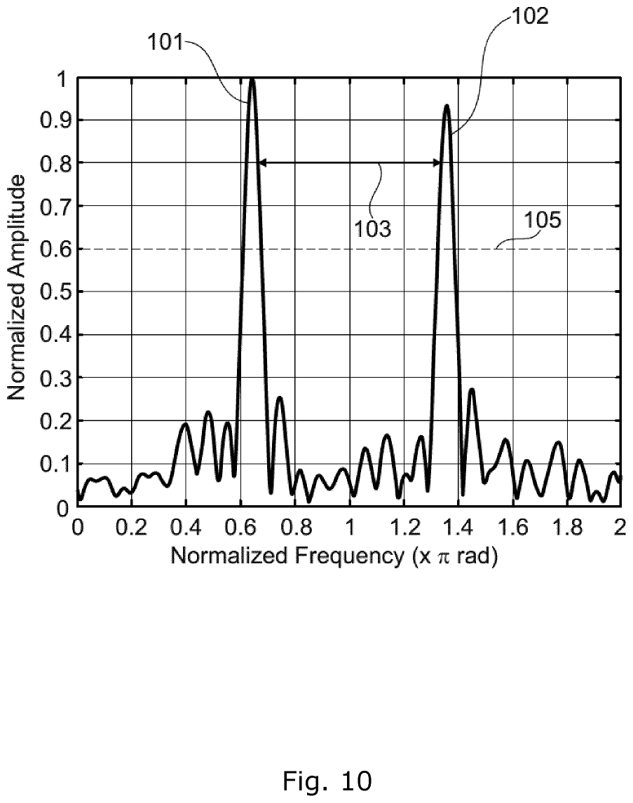

FIG. 10 is an illustration of local maximums, which are correlation peaks, observed in the phase lag dimension. The amplitude is a normalize amplitude, where the largest local maximum 101 has been normalized to an amplitude equal to 1. The second local maximum 102 is located with a distance 103 between the two local maximums. The distance 103 between the two local maximums is dependent on the data symbol sₖ, and therefore the distance between the two local maximums may be used to determine the data symbol. The location of the local maximums may be detected by estimating the frequencies where the amplitude is higher than a threshold value λ 105, which depends on the Probability of False Alarm P_{FA} defined based on the operating requirements of the radio signal device receiving the signal.

Note that the proposed concept does not impact the code delay estimation accuracy obtained with the multi-carrier signal.

Two different receiver operational scenarios are to be considered for the CAF generation at receiver level:
When the receiver is in tracking conditions of the baseline pilot signal, few time/frequency lags are needed in practice (time/frequency is known with good accuracy), such that only the phase lag dimension is to be assessed.
When the receiver is in acquisition conditions, the number of time/frequency lags assessed will be dependent on the initial conditions of the receiver, as per any conventional acquisition process.

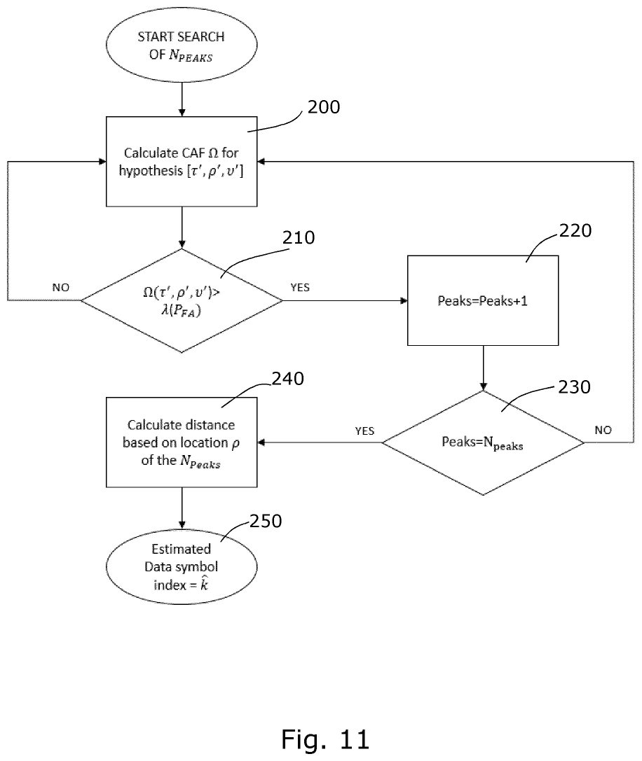

FIG. 11 is illustrating how the peaks or local maximums are counted. In step 200 the overall CAF Q calculated for selected values τ′, ν′, ρ′ for τ, ν, ρ. In step 210, the calculated value of the overall CAF Q is compared to the threshold value λ(P_{FA}). If the value of the overall CAF is higher than the threshold value λ(P_{FA}) then in step 220 one is added to the number of peaks. If the required number of peaks Nₚₑₐₖₛ are identified, then from the check in step 230, in step 240 the distance between the peaks are calculated and, in step 250, from the distance the data symbol with the index k is identified. If, in step 210, the calculated value is not higher than the threshold then the algorithm goes back to step 200 for a new set of selected values τ′, ν′, ρ′. Typically one of the parameters will be changed, for instance ρ′ will be increase slightly for the next calculation.

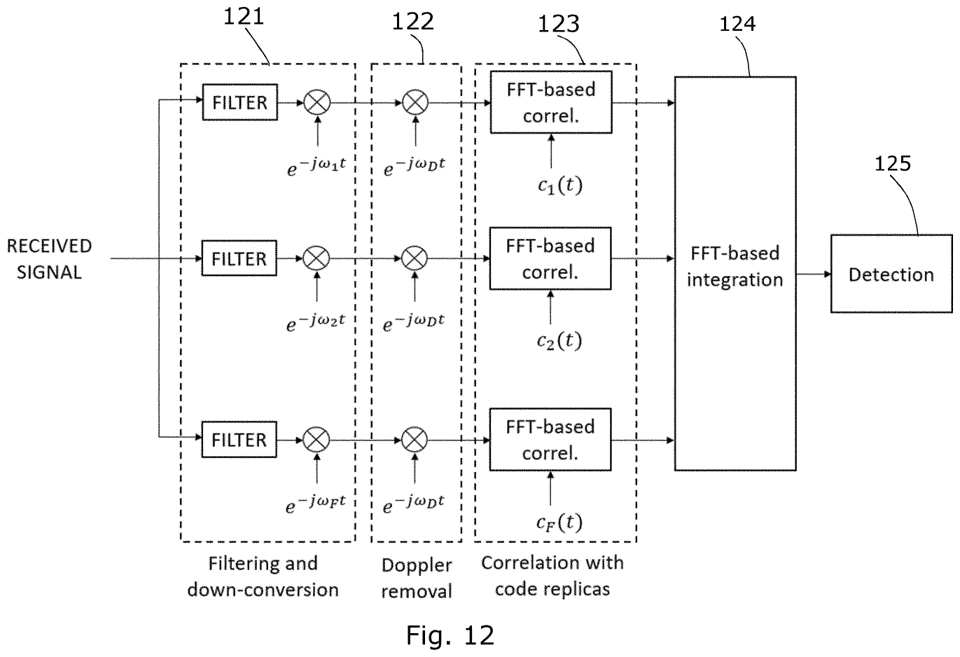

FIG. 12 illustrates a receiver architecture used for the acquisition of the received multi-carrier signal. In the first stage 121, a filtering and down-conversion process is applied for the conversion to base-band of the signal component rᵢ(t) in each carrier frequency fᵢ using the corresponding carrier wave sᵢ(t) of the form e(−jωᵢt). In the next stage 122, a correlator-based removal of the Doppler frequency of the received radio signal r(t) is applied using a carrier wave of the form e(−jω_{D}t), with WD the angular frequency shift introduced by the Doppler. In the next stage 123, an FFT-based correlation is applied to each of the resulting base-band signal per carrier frequency fᵢ with the corresponding spreading code sequence cᵢ(t). In the next stage 124, an FFT-based integration of the correlation contributions of all the carrier frequencies fᵢ is applied. In the last stage 125, a detection of the local maximum or local maximums above a certain threshold λ(P_{FA}) is performed.

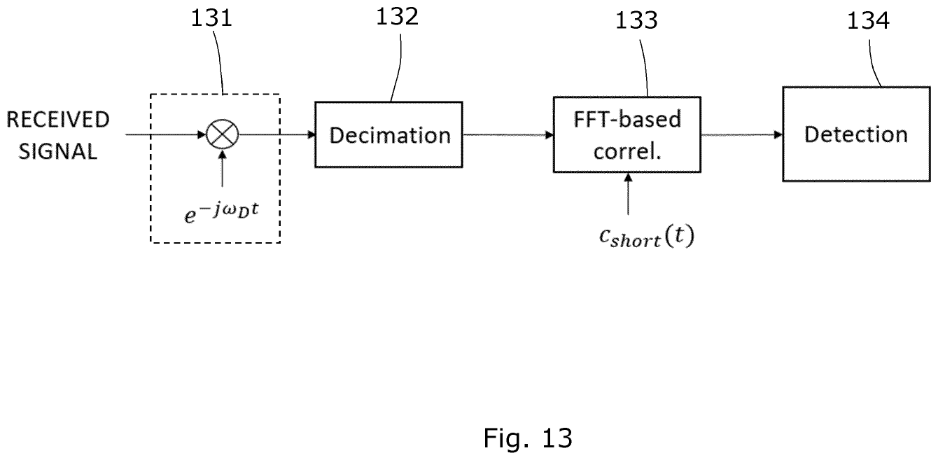

FIG. 13 illustrates a receiver architecture used for the acquisition of a short-code frequency-hopping (SC-FH) multi-carrier pilot signal. In the first stage 131, a correlator-based removal of the Doppler frequency of the received radio signal is applied using a carrier wave of the form e(−jω_{D}t), with ω_{D} the angular frequency shift introduced by the Doppler. In the next stage 132, a decimation, i.e. down-sampling, process is applied for the generation of an equivalent base-band signal, with a down-sampling frequency equal or below to the bandwidth of the short primary spreading code sequence cₛₕₒᵣₜ(t) transmitted in each carrier frequency fᵢ. In the next stage 133, an FFT-based correlation with the replica of the short primary spreading code sequence cₛₕₒᵣₜ(t) is applied. In the last stage 134, a detection of the local maximum above a certain threshold λ(P_{FA}) in the code-delay dimension is performed.

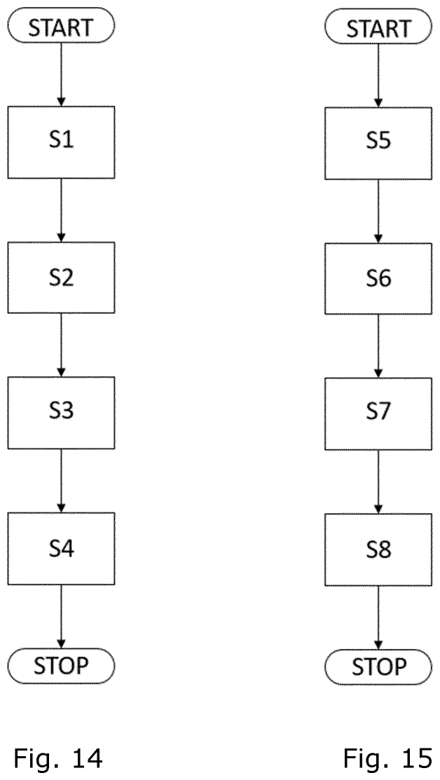

FIG. 14 illustrates the method for transmitting a radio signal. The method comprises the steps of
modulating (Step S1) the plurality of pilot symbol components dᵢ by a plurality of spreading code sequences cᵢ(t), which result is then modulated by a plurality of carrier waves sᵢ(t) to generate the baseline frequency components bᵢ(t), which are forming a baseline multi-carrier pilot signal b(t),
selecting (Step S2) a data symbol sₖ depending on an index k, with the index k applied to a certain block depending on the information transmitted,
modulating (Step S3) the baseline multi-carrier pilot signal b(t) with the data symbol sₖ, such that each baseline frequency component bᵢ(t) is multiplied by the corresponding i-th element s_{k,i} of the data symbol sₖ generating a plurality of modulated frequency components zᵢ(t), and
transmitting (Step S4) the radio signal z(k,t) comprising the block, which is comprising the plurality of pilot symbol components dᵢ and the data symbol sₖ.

FIG. 15 illustrates the method for receiving and synchronising a radio signal. The radio signal device is adapted for receiving the radio signal, which was transmitted as illustrated in FIG. 14. After receiving the radio signal r(t), the radio signal device is adapted to determine the index k of the data symbol sₖ of the received block (11), by:
demodulating (Step S5) each of the signal components rᵢ(t) with the carrier wave sᵢ(t) and the spreading code sequence cᵢ(t) to obtain a Cross-Ambiguity Function (CAF) Y_{k,I} of each signal component,
obtaining (Step S6) an overall CAF Ωₖ by combining the CAFs Y_{k,i}, of each signal component,
detecting (Step S7) local maximums (101, 102) above a threshold λ(P_{FA}) of the phase lag dimension p of the overall CAF Ωₖ,
determining (Step S8) the index k of the data symbol sₖ of the received block (11) based on the detected local maximums (101, 102) and the distance (103) between the local maximums in the phase lag dimension ρ.

The invention can be implemented by means of hardware, software, firmware or any combination of these. The invention or some of the features thereof can also be implemented as software running on one or more data processors and/or digital signal processors.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

### REFERENCES

[1]F. Zanier, and M. Luise, “Fundamental Issues in Time-Delay Estimation of Multicarrier Signals with Applications to Next-Generation GNSS”, Proceedings of the 10th International Workshop on Signal Processing for Space Communications 2008.
[2]L. Dai et al., “Positioning with OFDM Signals for the Next-Generation GNSS”, IEEE Transactions on Consumer Electronics, 56, 374-379. 2010.
[3]J-H Won et al., “Receiver Architecture for Multicarrier OFDM-based GNSS Signals”, in Proc. European Workshop on GNSS Signals and Signal Processing (GNSS Signals), Toulouse, France, 2011.
[4]J. A. Avila-Rodriguez et al., “A receiver and method for processing a ωide-band signal”, patent application PCT/EP2017/069235, 2017.
[5]J. G. Proakis, and D. G. Manolakis, “Digital Signal Processing. Principles, Algorithms, and Applications”, Third Edition, Prentice-Hall International, Inc. 1996.

1-24. (canceled)

25. A radio signal device adapted for transmitting a radio signal, wherein the transmitted radio signal z(k,t) comprises at least a block,
wherein the block comprises a pilot symbol d, the pilot symbol d comprises a plurality of pilot symbol components dᵢ, and a data symbol sₖ, the data symbol sₖ comprises a plurality of elements sₖ,i; the radio signal device is adapted to generate the radio signal z(k,t) by:
a. modulate the plurality of pilot symbol components dᵢ by a plurality of spreading code sequences cᵢ(t), which result is then modulated by a plurality of carrier waves sᵢ(t) to generate the baseline frequency components bᵢ(t), which are forming a baseline multi-carrier pilot signal b(t),
b. select a data symbol sₖ depending on an index k, wherein the index k represents the information to be transmitted by the block,
c. modulate the baseline multi-carrier pilot signal b(t) with the data symbol sₖ, such that each baseline frequency component bᵢ(t) is multiplied by the corresponding i-th element sₖ,j of the data symbol sₖ generating a plurality of modulated frequency components zᵢ(t), and
d. transmit the radio signal z(k,t) comprising the block, which is comprising the plurality of pilot symbol components dᵢ and the data symbol sₖ.

26. A radio signal device adapted for receiving and synchronising a radio signal, wherein a received radio signal r(t) comprises a plurality of signal components rᵢ(t) in at least a block (11), and the block comprises a data symbol sₖ, the data symbol sₖ comprises a plurality of elements s_{k,i} depending on an index k; the received radio signal r(t) being transmitted from a transmitting radio signal device transmitting a radio signal z(k,t);
the transmitting radio signal device before transmitting the radio signal z(k,t)
modulates a plurality of pilot symbol components dᵢ by a plurality of spreading code sequences cᵢ(t), which result then being modulated by a plurality of carrier waves sᵢ(t) to generate the baseline frequency components bᵢ(t), which are forming a baseline multi-carrier pilot signal b(t), and
modulates the baseline multi-carrier pilot signal b(t) with the data symbol sₖ, such that each baseline frequency component bᵢ(t) is multiplied by the corresponding i-th element s_{k,i} of the data symbol sₖ generating a plurality of modulated frequency components zᵢ(t),
then the transmitting radio signal device transmits the radio signal z(k,t) comprising the block, which is comprising the plurality of pilot symbol components dᵢ and the data symbol sₖ;
the radio signal device adapted for receiving the radio signal r(t), after receiving the radio signal r(t), is adapted to determine the index k of the data symbol sₖ of the received block, by:
a. demodulate each of the signal components rᵢ(t) with the carrier wave sᵢ(t) and the spreading code sequence cᵢ(t) to obtain a Cross-Ambiguity Function (CAF) Y_{k,i} of each signal component,
b. obtain an overall CAF Ωₖ by combining the CAFs Y_{k,i}, of each signal component,
c. detect local maximums above a threshold a (P_{FA}) of the phase lag dimension p of the overall CAF Ωₖ,
d. determine the index k of the data symbol sₖ of the received block based on the detected local maximums and the distance between the local maximums in the phase lag dimension ρ.

27. The radio signal device according to claim 26, wherein an integration period T to generate the overall CAF Ωₖ is less than or equal to a duration time Y of transmitting the block.

28. The radio signal device according to claim 26, wherein to retrieve the data symbol sₖ, the generation of the overall CAF Ωₖ is performed in an integration period T below or equal to the duration time Y of transmitting the block, with the number of samples, and the range covered in the time lag, angular frequency lag, and the phase lag dimensions being selected depending on the receiver operating conditions.

29. The radio signal device according to claim 26, wherein the two or more local maximums are detected in the phase lag dimension p of the overall CAF Ωₖ generated, with the number of local maximums to be detected depends on the data symbol sₖ.

30. The radio signal device according to claim 29, wherein the index k is determined as a function of the estimated relative distance between the set of local maximums detected.

31. The radio signal device according to claim 26, wherein at least one of (i) the blocks are transmitted consecutively, one after the other, forming a continuous signal, (ii) the blocks are transmitted in snapshots at any arbitrary time and/or with a certain duty-cycle, (iii) the duration time Y of transmitting a block is varying, (iv) wherein the data symbol sₖ is a vector comprising a number of elements, each element is a function of the step-phase Δφ_{k,d} and/or the offset-phase φ_{0,k,d} and/or the global-step-phase Δθ_{k,d}, and (v) wherein the data symbol sₖ is a vector comprising a number of elements s_{k,i}, where the i-th element is defined as
$${s}_{k , i} = {\sum }_{d = 1}^{D} {p}_{d} \cdot exp \{ j ( i - 1 ) Δ {θ}_{k , d} \} \cdot f ( exp \{ j [ ( i - 1 ) {Δφ}_{k , d} + {φ}_{0 , k , d} ] \} ) ,$$
where
D≥1, and determines the number of step-phases Δφ_{k,d},
$${\sum }_{d = 1}^{D} {p}_{d} = 1 ,$$
k is the index k of the data symbol sₖ,
the functionf(x) is defined as f(x)=Re(x), or f(x)=Im(x), or f(x)=g(Re(x)), or f(x)=g(Im(x)), with g(y) a pass-band filter, and
Δφ_{k,d} and φ_{0,k,d} are respectively the step-phase and the offset-phase applied to the transmission of the data symbol,
Δθ_{k,d} is the global-step-phase applied to offsetting the location of all the local maximums.

32. The radio signal device according to claim 26, wherein the CAF Y_{k,i} of each signal component is obtained by
$${{Υ}_{k , i}}_{} ( τ , v ) = {\int }_{0}^{T} {B}_{i} ( {r}_{k} ( t ) ) {b}_{i}^{*} ( t - τ ) exp \{ jvt \} dt ,$$
wherein r(t) is the received radio signal, Bᵢ( ) is a band-pass filtering function, bᵢ* is the complex conjugated baseline frequency component, T is the integration period, τ is the time lag, ν is the angular frequency lag, and k is the index k of the data symbol sₖ, and j is the imaginary unit.

33. The radio signal device according to claim 26, wherein the overall CAF is obtained by
$${Ω}_{k} ( τ , v , ρ ) = {\sum }_{i = 1}^{F} {{Υ}_{k , i}}_{} ( τ , v ) exp \{ j ρ i \} ,$$
wherein F is is the number of frequency components, τ is the time lag, ν is the angular frequency lag, ρ is the phase lag, k is the index k of the data symbol sₖ, and j is the imaginary unit.

34. The radio signal device according to claim 26, wherein the acquisition of the received multi-carrier signal r(t) is performed by using the following receiver architecture:
a) a filtering and down-conversion stage to convert to base-band the signal component rᵢ(t) in each carrier frequency fᵢ using the corresponding carrier wave sᵢ(t);
b) a correlator-based stage to remove the Doppler frequency of the received radio signal r(t);
c) an FFT-based correlation stage of each of the resulting base-band signal per carrier frequency fᵢ with the corresponding spreading code sequence cᵢ(t);
d) an FFT-based integration stage of the correlation contributions of all the carrier frequencies fᵢ; and
e) a detection stage of the local maximum or local maximums above a threshold λλ (P_{FA}).

35. The radio signal device according to claim 25, wherein the multi-carrier pilot signal b(t) is generated based on the usage of an arbitrary short primary spreading code sequence cₛₕₒᵣₜ(t), with the code length of the primary spreading code sequence equal or below 1023 binary pulses, being the short primary spreading code sequence cₛₕₒᵣₜ(t) transmitted in a single carrier frequency fᵢ during a certain time period D, such that the same short primary spreading code sequence cₛₕₒᵣₜ(t) is transmitted one or multiple times consecutively during the time period D, until the same primary spreading code sequence cₛₕₒᵣₜ(t) is transmitted in a different carrier frequency fᵢ, forming a short-code frequency-hopping (SC-FH) multi-carrier signal.

36. The radio signal device according to claim 35, wherein the acquisition of the short-code frequency-hopping (SC-FH) multi-carrier pilot signal b(t) is performed by using the following receiver architecture:
a) a correlator-based stage to remove the Doppler frequency of the received multi-carrier signal;
b) a decimation down-sampling stage to generate an equivalent base-band signal, with a down-sampling frequency equal or below to the bandwidth of the short primary spreading code sequence cₛₕₒᵣₜ(t) transmitted in each carrier frequency;
c) an FFT-based correlation stage with the replica of the short primary spreading code sequence cₛₕₒᵣₜ(t); and
d) a detection (134) of the local maximum above a threshold a (P_{FA}) in the code-delay dimension.

37. The radio signal device according to claim 25, wherein the multi-carrier pilot signal b(t) is an orthogonal frequency-division multiplexing (OFDM) signal.

38. The radio signal device according to claim 25, wherein the multi-carrier pilot signal b(t) is a frequency-hopping spread spectrum (FHSS) signal.

39. The radio signal device according to claim 25, wherein multiple multi-carrier pilot signals b(t) are transmitted in parallel in multiple frequency bands.

40. The radio signal device according to claim 25, wherein the radio signal is used in a Global Navigation Satellite System (GNSS).

41. The radio signal device according to claim 25, wherein the radio signal is used based on a Medium-Earth Orbit (MEO), Low-Earth-Orbit (LEO) and/or Geosynchronous Equatorial Orbit (GEO) satellite constellation.

42. The radio signal device according to claim 26, wherein the signal detection and/or data symbol retrieval comprises the detection and/or estimation of one or multiple local maximums from one or multiple radio signals received from different satellites for the exploitation of spatial diversity.

43. A method for transmitting a radio signal for a radio signal device, wherein
(i) the transmitted radio signal z(k,t) comprises at least a block,
wherein the block comprises a pilot symbol d, the pilot symbol d comprises a plurality of pilot symbol components dᵢ, and a data symbol sₖ, the data symbol sₖ comprises a plurality of elements sₖ,i; the radio signal device is adapted to generate the radio signal z(k,t) by:
a. modulating the plurality of pilot symbol components dᵢ by a plurality of spreading code sequences cᵢ(t), which result is then modulated by a plurality of carrier waves sᵢ(t) to generate the baseline frequency components bᵢ(t), which are forming a baseline multi-carrier pilot signal b(t),
b. selecting a data symbol sₖ depending on an index k, wherein the index k represents the information to be transmitted by the block,
c. modulating the baseline multi-carrier pilot signal b(t) with the data symbol sₖ, such that each baseline frequency component bᵢ(t) is multiplied by the corresponding i-th element s_{k,i} of the data symbol sₖ generating a plurality of modulated frequency components zᵢ(t), and
d. transmitting the radio signal z(k,t) comprising the block, which is comprising the plurality of pilot symbol components dᵢ and the data symbol sₖ, or
(ii) a received radio signal r(t) comprises a plurality of signal components rᵢ(t) in at least a block, and the block comprises a data symbol sₖ, the data symbol sₖ comprises a plurality of elements s_{k,i} depending on an index k; the received radio signal r(t) being transmitted from a transmitting radio signal device transmitting a radio signal z(k,t);
the transmitting radio signal device, before transmitting the radio signal z(k,t),
modulates a plurality of pilot symbol components dᵢ by a plurality of spreading code sequences cᵢ(t), which result then being modulated by a plurality of carrier waves sᵢ(t) to generate the baseline frequency components bᵢ(t), which are forming a baseline multi-carrier pilot signal b(t), and
modulates the baseline multi-carrier pilot signal b(t) with the data symbol sₖ, such that each baseline frequency component bᵢ(t) is multiplied by the corresponding i-th element s_{k,i} of the data symbol sₖ generating a plurality of modulated frequency components zᵢ(t);
then the transmitting radio signal device transmits the radio signal z(k,t) comprising the block, which is comprising the plurality of pilot symbol components dᵢ and the data symbol sₖ;
the radio signal device adapted for receiving the radio signal, after receiving the radio signal r(t), is adapted to determine the index k of the data symbol sₖ of the received block, by:
e. demodulating each of the signal components rᵢ(t) with the carrier wave sᵢ(t) and the spreading code sequence cᵢ(t) to obtain a Cross-Ambiguity Function (CAF) Y_{k,i} of each signal component,
f. obtaining an overall CAF Ωₖ by combining the CAFs Y_{k,i}, of each signal component,
g. detecting local maximums above a threshold, (P_{FA}) of the phase lag dimension p of the overall CAF Ωₖ,
determining the index k of the data symbol sₖ of the received block based on the detected local maximums and the distance between the local maximums in the phase lag dimension ρ.
